(19) United States
(12) Patent Application Publication
(10) Pub. No.: US 2007/0149168 A1
(43) Pub. Date: Jun. 28, 2007

(54) Billing system for usage fees in a content distribution system

(75) Inventor: Keiji Hariki, Sunnyvale, CA (US)

Correspondence Address: COURTNEY STANIFORD & GREGORY LLP, P.O. BOX 9686, SAN JOSE, CA, 95157, US

(73) Assignee: Innopath Software Inc.

(21) Appl. No.: 11/477,083

(22) Filed: Jun. 27, 2006

Related U.S. Application Data
(60) Provisional application No. 60/753,107, filed on Dec. 22, 2005.

(51) Int. Cl. H04M 11/00

(52) U.S. Cl. 455/405

(57) ABSTRACT

Embodiments of a content distribution and billing system for wireless communication networks are described. A wireless service provider provides network service to users of mobile communication devices. One or more third party content providers serve content data to the mobile communication devices. Content data is downloaded to the mobile communication device with free advertising content. A content distribution and billing process on the content provider server computer facilitates the charging of usage fees to the content providers based on usage of the downloaded content by the mobile device user. A content setting module on the mobile device sets the status of the downloaded content based on the viewing of an ad message associated with the downloaded content data. A content setting information collection process on the service provider server computer registers the content setting status with a billing database and bills the appropriate content provider based on billing information provided by the billing database.

### CROSS REFERENCE TO RELATED APPLICATIONS

The present application claims priority to U.S. Provisional Application No. 60/753,107, and filed on Dec. 22, 2005.

### FIELD

Embodiments of the invention relate generally to communication networks and more specifically, to a billing system for charging usage fees for content distribution network.

### BACKGROUND

The development of wireless mobile technology beyond simple point-to-point cell phones has led to the proliferation of mobile devices that are increasingly able to access data from various different sources and process many different types of content data. Mobile services have been developed that allow users to download various types of data and programs, such as games, music, video clips, and so on, for use on their mobile devices. This has led to the expansion of mobile phones beyond mere communication devices, but as processing platforms for a variety of different tasks. This network model has created a number of different possible providers of data and services to the user beyond the traditional single Internet Service Provider (ISP) or telecommunications provider (telephone company) model. In traditional network systems, a sole service provider is able to closely control content distribution and usage by users in the system. Charging and billing for such usage and content distribution is therefore relatively easy since the single service provider typically maintains control over all aspects of content distribution, user communications, and usage monitoring.

Under new network models, however, content data and even services or applications may be provided to end users by different third party companies other than the main service provider. The usage of such third-party content may utilize system resources that are not provided or maintained by the third-party content provider, but rather by the main service provider. However, because the main service provider does not necessarily control the distribution and usage of this third party content by the end users, the service provider may not be able to monitor such usage, and charge fees for the distribution and use of this content.

What is needed, therefore, is a system that allows a main service provider to charge and collect usage fees based on content provided by third party providers to end-users in a network.

### BRIEF DESCRIPTION OF THE DRAWINGS

Embodiments of a billing system for third party content distribution in a wireless network are illustrated by way of example and not limitation in the figures of the accompanying drawings, in which like references indicate similar elements and in which:

FIG. 1 is a block diagram of a communications network system that implements embodiments of a content distribution and billing system, under an embodiment.

FIG. 2 is a functional diagram of a content distribution and billing system, under an embodiment.

FIG. 3 is an example of a content setting information table, according to an embodiment.

FIG. 4 is a flowchart that illustrates a method of billing usage fees in a content setting and distribution system, according to an embodiment.

### DETAILED DESCRIPTION

Embodiments of a content distribution and billing system are described. Aspects of the one or more embodiments described herein may be implemented on one or more computers or computing devices executing software instructions. The computers may be networked in a client-server arrangement or similar distributed computer network. Embodiments are directed to network systems that incorporate a telecommunications or similar wireless network system.

A wireless service provider provides network service to users of mobile communication devices. One or more third party content providers serve content data to the mobile communication devices. Content data is downloaded to the mobile communication device with free advertising content. A content distribution and billing process on the content provider server computer facilitates the charging of usage fees to the content providers based on usage of the downloaded content by the mobile device user. A content setting module on the mobile device sets the status of the downloaded content based on the viewing of an ad message associated with the downloaded content data. A content setting information collection process on the service provider server computer registers the content setting status with a billing database and bills the appropriate content provider based on billing information provided by the billing database.

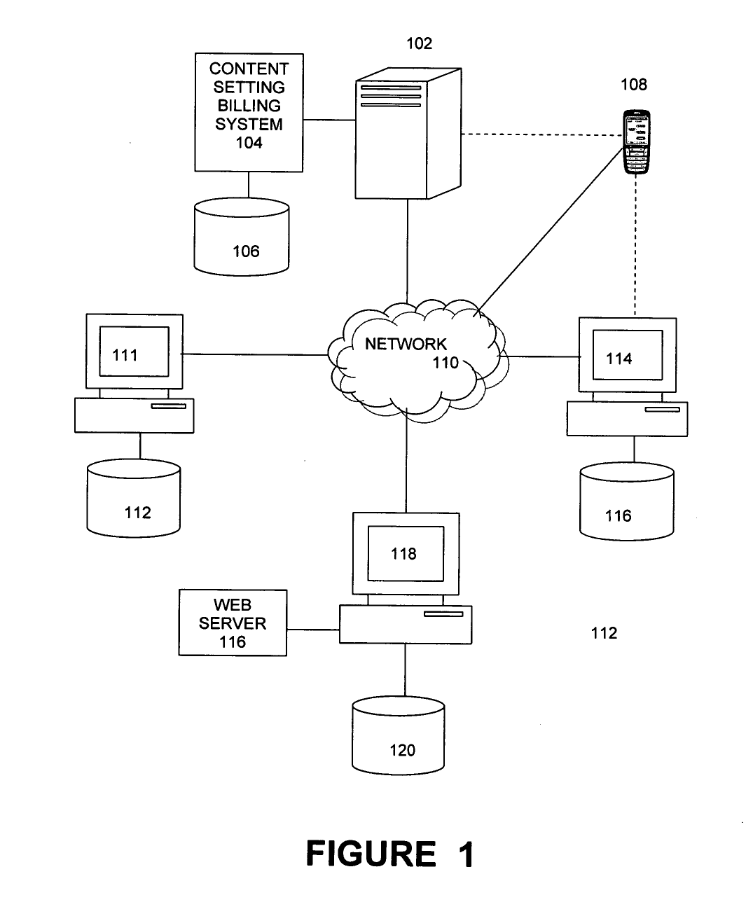

FIG. 1 illustrates a communications network system 100 that implements one or more embodiments of a content distribution and billing system. In system 100, a service provider server computer 102 provides network access to one or more mobile devices, such as mobile phone 108. In one embodiment, the mobile device 108 is a cellular phone and network 110 is a comprehensive telecommunications network that includes both a cellular phone network and the Internet. Network 110 may also include one or more Wide Area Networks (WAN), Local Area Networks (LAN), or any combination thereof. Server computer 102 can be a wireless service provider or Internet Service Provider or combination of both. The mobile device 108 communicates with other mobile devices over the wireless portion of network 110, such as other cellular telephones over the cellular network. The mobile device 108 can also be configured to communicate with one or more client and/or server computers that are directly or indirectly coupled to network 110.

In one embodiment, computers 111, 114, and 118 are content provider servers that provide content data, application programs, diagnostic tools, program components, or any other content or executable objects to the mobile device 108. One or more of the content provider computers is a World-Wide Web (WWW) server that stores data in the form of web pages and transmits these pages as Hypertext Markup Language (HTML) files over the Internet 110 to the mobile device 108 or other client computer on the network. For example, server 118 executes a web server process 116 to serve web pages over network 110. For this embodiment, the mobile device 108 runs a web browser program to access the web pages served by server computer 118 and any available content provider or supplemental server 111 and 114.

In a typical implementation, the mobile device user 108 pays the service provider 102 a one-time or monthly fee to use the network 108. This fee typically covers usage fees associated with communicating with other mobile device users and use of certain features associated with the subscription plan, such as messaging, diagnostics, tools, programs, and the like. For the embodiment illustrated in FIG. 1, the content provider servers 111, 114 and 118 provide content to the mobile device user 108 that is not included in the service provider plan. These servers are typically operated by third parties that provide supplemental content or programs to the user that require some usage of the network resources provided by the service provider 102.

In one embodiment, server 102 in network system 100 is executes a server side content setting and billing system 104. Client versions of this process may also be executed on the mobile device 108. The server process 104 may represent one or more executable programs modules that are stored within network server 104 and executed locally within the server. Alternatively, however, it may be stored on a remote storage or processing device coupled to server 102 or network 110 and accessed by server 102 to be locally executed. In a further alternative embodiment, the content setting and billing system 104 may be implemented in a plurality of different program modules, each of which may be executed by two or more distributed server computers coupled to each other, or to network 110 separately. The server computer 102 also maintains a billing database 106 that is accessed by the content setting and billing process 104.

The user of the mobile device 108 can download content objects from one or more of the content providers. The downloaded content utilizes the resources provided by the service provider 102, but is not directly controlled by the service provider. The content setting and billing process 104 facilitates the billing of usage charges associated with the use of the downloaded content. The system usage fee is set by the wireless operator. If the user only downloads a content object from a content provider, no usage fee is charged. If, however, the user executes, views, or otherwise accesses the content object on his or her mobile device, a usage fee is charged by the service provider typically to the content provider. In one embodiment, the content provider charges a content sponsor. The content sponsor provides advertisements or other supplemental data associated with the content provided by the content provider.

Any or all of the client computers in system 100 may be a workstation computer or they may be a computing device such as a notebook computer, personal digital assistant, or the like. The client computers may also be embodied within a mobile communication device, game console, or similar computing device that provides access to the Internet network 110 and a sufficient degree of user input and processing capability to execute or access the application programs. The client computers 111, 114 and 118 may be coupled to the network 110 over a wired connection, a wireless connection or any combination thereof.

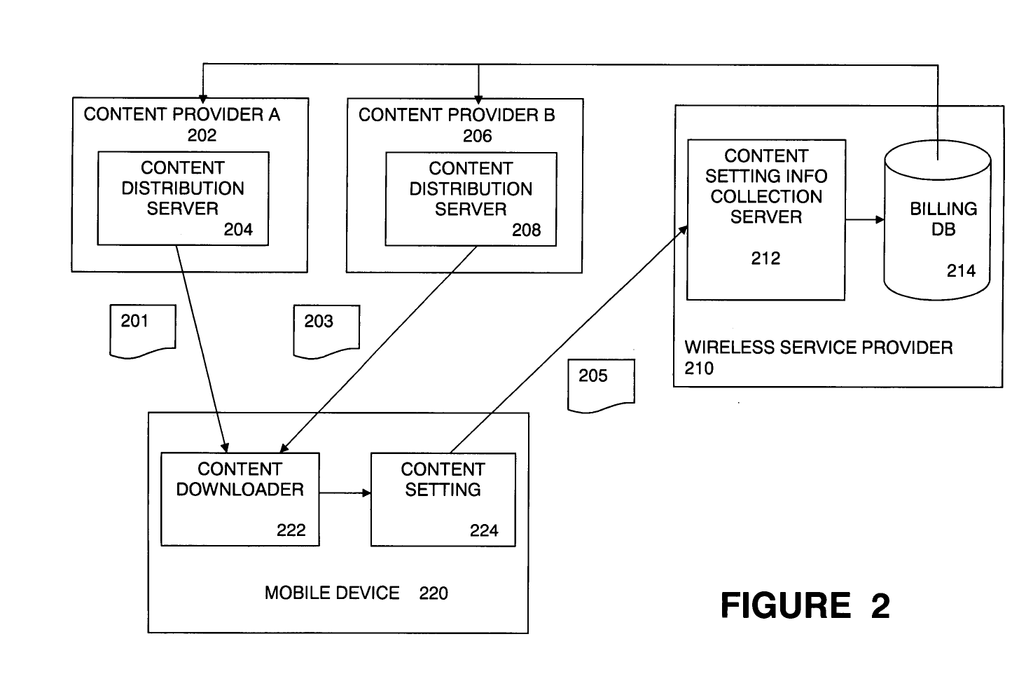

FIG. 2 is a functional block diagram of content distribution and billing system, under an embodiment. Content is downloaded to mobile device 220. In one embodiment, the content can comprise images, video clips, music or other sound clips, ringtones, games, small applications (applets), utilities, diagnostic tools, or any other similar data or applications, all of which are referred to as “content objects.” Content can be provided by a number of different content providers, such as content provider A and B in FIG. 2. Typically, content is downloaded upon demand, such as when the user requests content from a particular content provider. Alternatively, content can be pushed to the user from a content provider based on a periodic subscription arrangement, trial use, or similar mechanism. In general, no usage charge is incurred when a user merely downloads the content. Upon using the content, however, a usage charge is incurred.

In one embodiment, the content incorporates one or more advertising messages in the form of graphic images, streaming video, audio clips, text message, or similar form or combination thereof. The advertising messages are typically provided for free and can be incorporated in the content data or associated with the content through tags or similar mechanisms that link an advertising message with particular content data objects. The advertising messages can be sourced by the same content provider as the associated content data, or they can be provided by a separate content provider, such as a content sponsor or advertisement server.

Each content provider operates a content distribution server to package and transmit the content objects to the mobile device 220. Thus, as shown in system 200, content provider A 202 has content distribution server 204 which downloads content data objects 201 to the mobile device 220; and content provider B 206 has content distribution server 208 which downloads content data objects 203 to the mobile device. The mobile device 220 includes a content downloader module 222 to receive the content data objects. Once the content is received it can be viewed, heard, executed or otherwise perceived or used by the user depending upon the file type of content, e.g., audio clip, video clip, ringtone, applet, etc. When the user uses, executes or otherwise perceives the downloaded content data, the associated advertising messages also plays or executes. Thus, the user essentially sees or hears an ad when he or she uses the content. The viewing of the ad triggers a usage fee that is charged by the wireless service provider 210.

In one embodiment, the wireless service provider 210 provides an authoring tool to the content providers 202 and 206. The authoring tool allows the content providers to create content packages embodying the content and ad messages to be downloaded to the mobile device. The content package includes information about the content provider, such as provider identifier, location, security mechanisms, and so on. The content package also includes information about the content data provided by the content provider, as well as any other associated data, such as supplemental data or the linked advertising messages. The content package can also include information regarding compatible target mobile devices, such as manufacturer, model, specifications, operating parameters, and so on. The authoring tool allows the service provider 210 to dictate or control the packaging of the distributed content and establish triggers (such as ad viewing) that indicate when a usage fee should be charged.

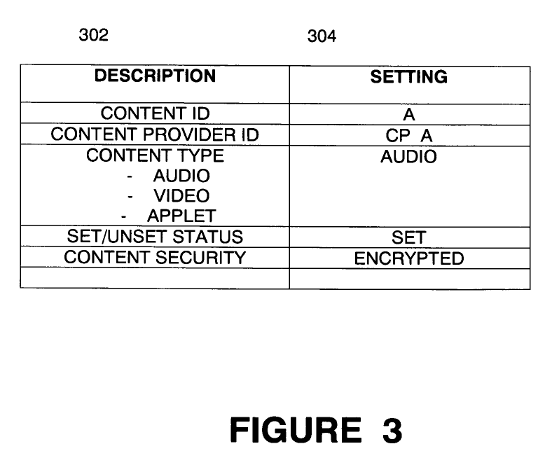

The mobile device 220 includes a content setting module 224 that sets and unsets the content data to the system software on the mobile device 220. In one embodiment, the use of the downloaded causes the system software to access or execute the content data object and thereby “sets” the content. The content setting module detects whether the content data has been used by determining whether the associated advertising message has been played. It is then assumed that the user has viewed the ad. Content data that has not yet been used or accessed, but merely downloaded is defined as “unset.” The content setting module 224 also defines the content setting information and transmits this information to the wireless service provider. The content setting information comprises information regarding the content data object, and can include information such as content identifier, content type (e.g., video, audio, text, etc.), file size, encryption or compression method, and other similar parameters. The content setting information is typically stored in the form of database or spreadsheet tables in memory of the mobile device that is accessible to the content setting module 224. FIG. 3 is an example of a content setting information table, according to an embodiment. Column 302 of table 300 includes a description of the content setting information items, and includes content ID, content provider ID, and so on. Associated example values for each item are illustrated in column 304 of table 300.

As shown in FIG. 2, the wireless service provider 210 that supports the mobile device 220 maintains a computer system that includes a content setting information collection server 212 and a billing database 214. The content setting information collection server 212 embodies a portion of the content setting and billing process 204 illustrated in FIG. 1. The content setting information is sent by the content setting module 224 on the mobile device 220 to the content setting information collection server 212. This server then registers the content setting status information with the billing database 214. The billing database is then used to charge the appropriate system usage fee to the content provider based on the billing information contained in the billing database. Typically, content data for which the content setting status is “set” is charged to the content provider that transmitted the content to the mobile device.

The usage fee associated with use of content data provided by a content provider can be set to virtually any value decided upon by the wireless service provider. Usage fees can be based on a variety of revenue models, such as a base fee for all downloads by a content provider, a per-download fee, or any similar method. If the content is sponsored by a separate content sponsor or advertiser, the content provider may pass on the usage fee or recoup part or the entire usage fee from the sponsor. Typically, content is provided free of charge to the user of the mobile device, so that the usage cost is borne by the content provider and/or content sponsor. In some cases, however, usage fees may be shared in whole or in part by the mobile device user, depending upon subscription or fee arrangements among the content provider, wireless service provider, and user.

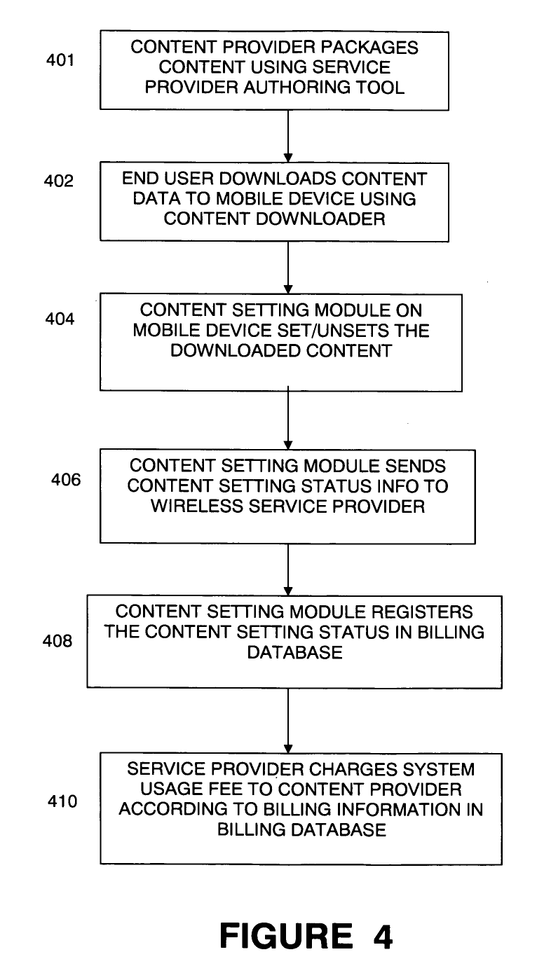

FIG. 4 is a flowchart that illustrates a method of billing usage fees in a content setting and distribution system, according to an embodiment. The method begins in step 401 by the content provider packaging the content to be downloaded using an authoring tool provided by the wireless service provider. In step 402, the user downloads the content data from a particular content provider to his or her mobile device. The content downloader on the mobile device controls the downloading of the content. No usage charge is incurred by the user only downloading the content. Upon use of the downloaded content, the content setting module on the mobile device sets the downloaded content data and defines the content setting status information, step 404. In step 406, the content setting module on the mobile handset sends the content setting status information to the content setting information collection server of the wireless service provider. The content setting information collection server then registers the content setting status information with the billing database, step 408. At the prescribed time, the wireless service provider charges the system usage fee to the appropriate content provider based on the billing information in the billing database, step 410.

Aspects of the content distribution and billing system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the content distribution and billing system is not intended to be exhaustive or to limit the embodiments to the precise form or instructions disclosed. While specific embodiments of, and examples for, the newsletter hosting and transmission system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the content billing system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the content distribution and billing system may be presented in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A method of billing for usage of a network supported by a service provider, comprising:
providing an authoring tool to a content provider for defining content data transmitted by the content provider to a user of a mobile device on the network, the content data including one or more associated advertising messages;
receiving content status information from the mobile device, the content status information including an indication of the playing of the one or more associated advertising messages on the mobile device;
registering the content status information with a billing database; and
charging a usage fee to the content provider for content indicating that the one or more associated advertising messages have been played.

2. The method of claim 1 wherein the network is a cellular telephone network, the mobile device is a cellular phone, and the service provider is a cellular service provider.

3. The method of claim 1 wherein the content data comprises at least one of: an audio clip, a video clip, a program, a text message, and a program executable on the mobile device.

4. The method of claim 1 wherein the one or more associated advertising messages are provided by an advertising sponsor.

5. The method of claim 4 wherein the advertising sponsor bears a portion of the usage fee on behalf of the content provider.

6. The method of claim 1 wherein the content status information includes at least one of a content identifier, content provider identifier, content type, and associated advertisement viewing status.

7. A server computer for billing usage fees associated with use of content data downloaded to a mobile communication device from a third-party content provider, comprising:
a content setting billing system configured to receive content setting status information from the mobile communication device, the status information set to one of set or unset, wherein set denotes content data that has been used by the mobile communication device as indicated by a trigger condition; and
a billing database configured to store the content setting status information and information related to the content provider.

8. The system of claim 7 wherein the trigger condition is the transmission of an advertising message associated with the content data.

9. The system of claim 8 wherein the network is a cellular telephone network, the mobile device is a cellular phone, and the service provider is a cellular service provider.

10. The system of claim 9 wherein the content data comprises at least one of an audio clip, a video clip, a program, a text message, and a program executable on the mobile device.

11. The system of claim 9 wherein the one or more associated advertising messages are provided by an advertising sponsor.

12. The system of claim 11 wherein the advertising sponsor bears a portion of the usage fee on behalf of the content provider.

13. The system of claim 12 wherein the content status information includes at least one of a content identifier, content provider identifier, content type, and associated advertisement viewing status.

14. A computer-readable medium including executable instructions, which when executed in a processing system, bill for usage of a network supported by a service provider by:
providing an authoring tool to a content provider for defining content data transmitted by the content provider to a user of a mobile device on the network, the content data including one or more associated advertising messages;
receiving content status information from the mobile device, the content status information including an indication of the playing of the one or more associated advertising messages on the mobile device;
registering the content status information with a billing database; and
charging a usage fee to the content provider for content indicating that the one or more associated advertising messages have been played.

15. The computer readable medium of claim 14 wherein the content data comprises at least one of an audio clip, a video clip, a program, a text message, and a program executable on the mobile device.

16. The computer readable medium of claim 15 wherein the content status information includes at least one of a content identifier, content provider identifier, content type, and associated advertisement viewing status.
